(19) United States
(12) Patent Application Publication
(10) Pub. No.: US 2007/0278330 A1
(43) Pub. Date: Dec. 6, 2007

(54) Oozing Hose

(76) Inventor: Ting-I Lin, Hsin-Dian (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/421,745

(22) Filed: Jun. 1, 2006

(51) Int. Cl. B05B 15/00

(52) U.S. Cl. 239/547; 239/542

(57) ABSTRACT

An oozing hose, which discharges water for irrigation by oozing, is disclosed herein. The oozing hose comprises a hose body with a plurality of orifices formed thereon, and an oozing layer that covers an outer wall of the hose body. The oozing layer is capable of absorbing and oozing water. With the installation of the oozing layer, water may ooze through the hose body gradually to save water substantially during irrigation, and to improve the disadvantages of uneven water distribution and plant damage associated with conventional direct sprinkling devices.

### BACKGROUND OF THE INVENTION

1. Field of the Invention

The present invention relates to a hose structure, and in particular to an oozing hose which discharges water for irrigation by oozing.

2. The Prior Arts

Conventionally, plants are irrigated directly by manual irrigation with a watering apparatus or a hose nozzle to wet the soil in the vicinity of plants, so that the plants may absorb water which is essential for growth from the soil. However, in this method, a person who waters has to distribute the water to plants and the soil around them, which not only is inconvenient, but also is liable to wet and bemire the area in vicinity. In view of the disadvantages, a perforated pipe network is developed, which is buried below the soil level, and allows water to be discharged from the holes of the pipe after the water supply source is turned on to irrigate the area where the pipe network is installed. In this way, the person who waters no longer needs to carry a watering apparatus or drag a hose to water the plant one by one.

Another method, as an automatic irrigation system illustrated in FIG. 1, is to distribute water by means of a rotary sprinkler head 11. The sprinkler head 11 is installed in a rotary seat 12 connected to a branch pipe 13 that is connected with a main pipe 14. The installation of the automatic irrigation system is similar to that of the aforementioned perforated pipe system. A main pipe 14 is installed in the area to be irrigated, with the branch pipes 13 extending therefrom. When water is discharged, the action of the water discharge causes the sprinkler head 11 and the rotary seat 12 to rotate automatically, so that water is distributed covering a circle area defined with the branch pipe 13 as a center. Both methods sprinkle water to a surface of the soil and let the soil absorb water from the surface. However, the water retained in the surface of the soil evaporates easily because of the sun and the wind. In addition, to enable water to percolate to the root zone of the plant, a great amount of water is required in sprinkling, which increases the consumption and cost of water substantially. On the other hand, the difference of water pressure causes water to be sprinkled to different distances, which results in uneven water distribution, and, when the water is sprinkled to an undesired area, bemires the environment or even wets pedestrians. Furthermore, the uncovered pipes are not aesthetic, especially in garden design. Still further, some plants are tenderer than others. Irrigation with high-pressured water may damage the plants, the flowers, or the fruit easily. In this case, the aforementioned sprinkling systems are not applicable.

In addition, though irrigation device that irrigates by oozing water from a hose slowly is available heretofore, it is structured with an interlayer on a wall of the hose, with micro-passages formed therein. The micro-passages extend outwards and form oozing outlets on the hose to allow water to depressurize and ooze out of the hose. Such a hose requires special molds in manufacturing and is expensive to produce. Besides, it is applicable only in the surface level of the soil; otherwise the oozing outlets will be easily clogged by soil, which limits its application.

### SUMMARY OF THE INVENTION

In order to save water during irrigation, to increase water absorption of soil after sprinkling, to avoid uneven water distribution and plant damage caused by direct sprinkling, and to increase the aesthetic effect of hose installation, the present invention is to provide an oozing hose, which, by oozing water to the soil, lowers water consumption, improves the aforementioned disadvantages associated with conventional irrigation devices, and obtains better water discharging result with the simplest component assembly.

The oozing hose according to the present invention comprises a hose body with a plurality of orifices distributed thereon, and an oozing layer that covers an outer wall of the hose body. The oozing layer is capable of absorbing water and oozing water. The hose body may be a plastic flexible hose or a rigid pipe, but is not limited thereto. The oozing layer may be a fabric layer or a sponge layer, but is not limited thereto.

The oozing hose in accordance with the present invention will be buried below the soil level in the area to be irrigated. After the water supply source is turned on, water will fill the hose body, and be discharged from the orifices. As the hose body is covered with the oozing layer, water will not be sprinkled to the soil directly. The oozing layer absorbs the water and allows the water to ooze to the soil. In this way, irrigation by oozing is effected. In addition, the oozing hose in accordance with the present invention may be buried in the root zone of plants, so that when the soil is irrigated to a desired extent of moisture, irrigation may be stopped, which lowers the amount of water for irrigation and reduces water cost. On the other hand, the oozing layer isolates the hose body from the soil, which precludes the possibility of orifice clogged by soil. Besides, according to the present invention, the depressurized oozing effect that conventional complicated pipe structure tried to achieve is effected simply by the installation of an oozing layer, which is economical as far as manufacturing cost is concerned. Moreover, the present invention is buried below the surface level of the soil for irrigation, which improves the disadvantages of uneven water distribution and plant damage caused by high-pressured water associated with conventional irrigation devices. In this respect, the present invention is applicable not only to the sprinkling of common plants, but also to the irrigation of flowers or plants.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of a conventional irrigation device;

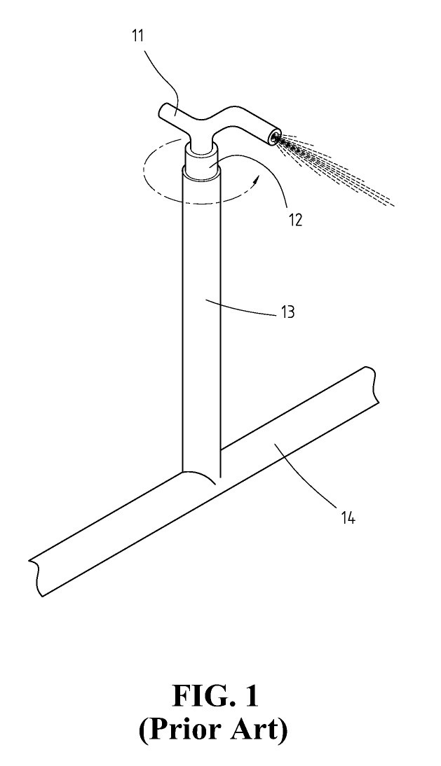

FIG. 2 is a schematic view of an oozing hose in accordance with a preferred embodiment of the present invention; and

FIG. 3 is a schematic view of the oozing hose of the present invention employed for irrigation after assembly.

### DETAILED DESCRIPTION OF THE PREFERRED EMBODIMENT

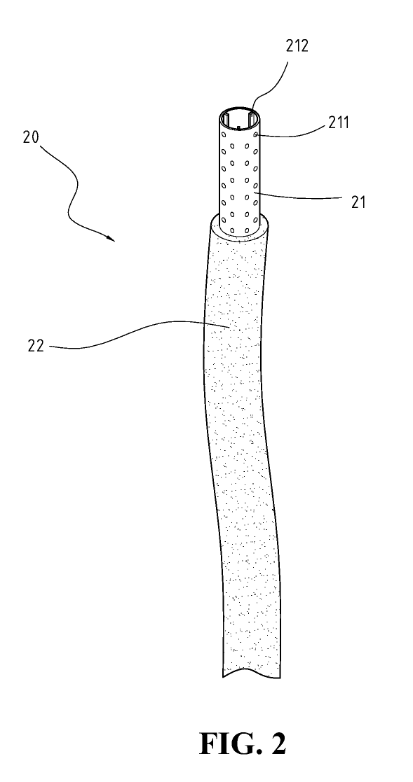

With reference to FIG. 2, an oozing hose in accordance with the present invention comprises a hose body 21 and an oozing layer 22 that covers an outer wall of the hose body 21.

A plurality of orifices 211 are formed on the hose body 21 to serve as water discharging outlets. There is no limit to the position of the orifices 211. They may be distributed evenly, and the number may be increased or decreased depending on the amount of water required for the irrigated area. The size of the orifices 211 depends on the amount of water to be sprinkled, the water pressure of the water supply source, and the water absorption and oozing efficiency of the oozing layer 22. There is no limit to the number and shape of the orifices 211, as long as they allow the desired amount of water to pass through. On the other hand, there is no limit to the material of the hose body 21, which may be a plastic flexible hose, a plastic rigid pipe, a copper pipe, or an iron pipe. Commonly, the plastic hose body 21 includes polybutylene (PB) pipe, polyethylene (PE) pipe, polyvinyl chloride (PVC) pipe, and polyvinyl acetate (EVA) pipe. Plastic hoses are preferred because they are easier to be perforated. When flexible hoses are employed, to avoid the soil from collapsing the hose and blocking the water flow, a plurality of supporting ribs 212 may be installed on an inner wall of the hose body 21 extending longitudinally to support the inner wall of the hose and ensure the flow of water.

Besides, there is no limit to the shape of the hose body 21. It may be oblate, cylindrical, or other shapes. If it is oblate, for water flow considerations, the supporting ribs 212 may be installed extending longitudinally on the inner wall of the hose body 21 to support the inner wall and ensure the flow of water.

The oozing layer 22 covers the outer wall of the hose body 21 directly. The material of the oozing layer may be fabric, sponge, or other material with water absorption and oozing capability, and is not limited specifically. To avoid the oozing layer from clogging and consequently affecting the oozing performance, material with pores that does not allow soil to pass through easily is preferred.

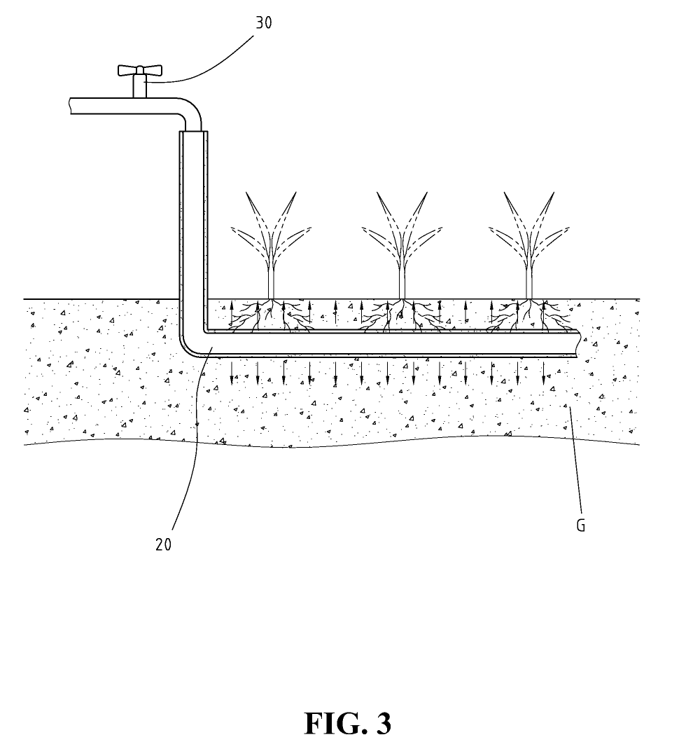

With reference to FIG. 3, the oozing hose 20 in accordance with the present invention is buried in the soil stratum G of the irrigation area. One end of the oozing hose 20 is connected with a water supply source 30, while the remaining part is buried in the soil stratum G After the water supply source 30 is turned on, water flows into the hose body 21, and discharges from the orifices 211 positioned thereon. As the hose body 21 is covered with the oozing layer 22, water will not be discharged into the soil directly. The oozing layer 22 prevents the water from discharging, absorbs the water, and enables the water to ooze into the soil. In this way, irrigation by oozing is achieved.

As the oozing hose 20 in accordance with the present invention may be buried at the root zone of plants, when the soil is irrigated to a desired extent of moisture, irrigation may be stopped, which reduces the amount of water required for irrigation substantially, and saves a lot of cost. On the other hand, the oozing layer 22 isolates the soil stratum G from the hose body 21, which precludes the possibility of the orifices 211 of the hose body 21 being clogged by soil. The installation of the oozing layer 22 not only achieves the depressurized oozing effect that conventional complicated pipe structure tried to obtain, but also reduces the manufacturing cost and simplifies the product assembly. Besides, the present invention is buried below the surface level for irrigation, which solves the disadvantages of aesthetical unpleasantness, uneven water distribution, and plant damage caused by high-pressured water associated with conventional sprinkling devices. Accordingly, the present invention is applicable not only to the sprinkling of common plants, but also to the irrigation of flowers and plants.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An oozing hose, comprising
a hose body having a plurality of orifices distributed evenly around the circumference of the hose body;
an oozing layer having a thickness no more than a diameter of the hose body, and no less than a quarter of a diameter of the hose body, said oozing layer covering an outer wall of said hose body leaving no free space between said oozing layer and said outer wall for free flowing of liquid;
wherein the oozing layer is made with material having pore sizes that does not allow soil to pass though easily, and such material absorbs water evenly thoughout the oozing layer to create a depressurized zone in the oozing layer such that water from said hose body does not directly discharge into an outside environment without first completely soak though the entire said oozing layer, and then allows water to slowly ooze out of said oozing layer:
wherein said oozing layer is comprised of sponge: and
wherein a plurality of supporting ribs are formed extending longitudinally on an inner wall of said hose body.

2. The oozing hose as claimed in claim 1, wherein said hose body is a plastic flexible hose.

3. (canceled)

4. (canceled)

5. The oozing hose as claimed in claim 1, wherein said hose body is a plastic rigid pipe.

6. The oozing hose as claimed in claim 1, wherein said oozing layer is further comprises fabric.

7. (canceled)
